(19) United States
(12) Patent Application Publication
(10) Pub. No.: US 2012/0173789 A1
(43) Pub. Date: Jul. 5, 2012

(54) ALBUM USB

(75) Inventor: Wendy Heather McClendon, Bloomfield Hills, MI (US)

(73) Assignee: Daleth Music Group

(21) Appl. No.: 12/910,058

(22) Filed: Jan. 3, 2011

(51) Int. Cl. G06F 12/00

(52) U.S. Cl. 711/103; 711/E12.001

(57) ABSTRACT

The Daleth Album USB (Daleth) is an album applied to a USB used for the purpose of listening, storing and distributing music. The functionality is that the Daleth Album USB is to act as an audio record or compact disc (CD) for the music, and the outside is to act as an audio record cover or CD case in which it has the artist(s) image or the image to represent the album along with album title. The Daleth Album USB can be used in computers, exercise machines, vehicles with USB ports, radios with USB ports, and other devices with USB compatibility.

### REFERENCES CITED

### U.S. Patent Documents

| | | |
|---|---|---|
| 5,694,555 | December 1997 | Morriss et al. |
| 3,876,134 | Apr. 8, 1975 | Rice et al. |
| 7,384,295 | Jun. 10, 2008 | Hankey et al. |
| 7,671,630 | Mar. 2, 2010 | Howe et al. |
| 7,752,460 | Jul. 6, 2010 | Shibuya et al. |
| 7,797,456 | Sep. 14, 2010 | Morita et al. |
| 7,816,942 | Oct. 19, 2010 | Howe et al. |

### Other References

¹ http://en.wikipedia.org/wiki/Album

“Recording Technology History”. http://history.sandiego.edu/gen/recording/notes.html.

“Chronomedia”. http://www.terramedia.co.uk/Chronomedia/years/1909.htm.

“Rules For Chart Eligibility—Albums” The Official UK Charts Company. January 2007. Archived from the original on Jun. 27, 2007.

www.theofficialcharts.com/docs/NEW_Album_Chart_Rules_{—}2007_{—}2.pdf. Retrieved 2007-4-20.

### FEDERALLY SPONSORSHIP

Not Applicable.

### PARTIES

McClendon; Wendy H. (Southfield, Mich.)

McClendon; Joseph L. (Southfield, Mich.)

### BACKGROUND OF THE INVENTION

An album or record album is a collection of related audio or music tracks distributed to the public. Today, the vinyl record is no longer being used as the primary form of distribution. The term “album” is still be applied to any sound recording collection, such as those on compact disc, MiniDisc, Compact audio cassette, and digital or MP3 albums.' Cover art is also considered an integral part of the album. The Daleth Album USB incorporates both the storage of music tracks, and the cover art externally.

The Daleth Album USB utilizes the USB to listen, store and distribute music. The Universal Serial Bus (USB) was created by Ajay Bhatt to increase communication between devices and a host controller. The Daleth Album USB use of the USB is to reduce damage to albums through the USBs durability, and increase portability.

### SUMMARY OF THE INVENTION

The purpose of the Daleth Album USB is to listen and distribute music. Currently, to listen to music, compact discs, tapes, vinyl records and downloadable are utilized. The current use for USBs is primarily for transfer of computer data.

The usage of the Daleth Album USB that is being applied is application of an album (music) to a USB along with cover art. This will translate into use the Daleth Album USB being utilized in computers, exercise machines, vehicles with USB ports, radios with USB ports and more. This usage of the Daleth Album USB addresses the prevention of music storage devices (compact discs, records, tapes, etc.), and reduces the amount of music and music quality being damaged. Current music storage devices can be physically touched and destroyed, compromising the music and quality of music. Vinyl albums can become warped, and CDs can be scratched. With the Daleth Album USB, it is possible to touch physically, but less risk of damage due to the Album USB's sturdiness and durability.

The Daleth Album USBs is compact, and smaller than current music storage devices (compact discs, records, tapes). The Daleth Album USB is advantageous to the market because it is compact in that it will take up less space storing. In retail, the Daleth Album USB will take up less shelf space than current music storage devices, and aid in warehousing issues.

### BRIEF DESCRIPTION OF THE DRAWINGS

There are two (2) views of the Daleth Album USB; front and back.

FIG. 1: Is the front view of the Daleth Album USB where cover art is displayed.

FIG. 2: Is the back view of the Daleth Album USB that houses the USB plug.

### DETAILED DESCRIPTION

The Daleth Album USB is compact in size. The prototype's dimensions are approximately 8.5 mm×5.5 mm×0.3mm. The size of the Daleth Album USB can change for adaptability or ease of use. The Daleth Album USB has two constant components; the interior stores a music album, and the exterior exhibits album cover art and the USB plug.

### Exterior:

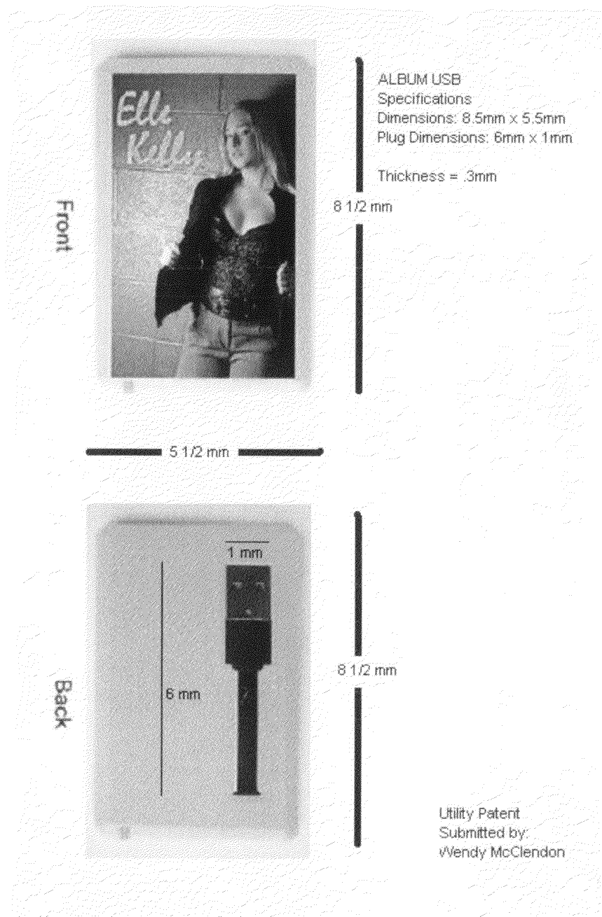

### FIG. 1: Front View

On the front is album cover art. Typically, a music artist, group, image, and/or album title is considered cover art.

FIG 2: Back View

On the back, is a USB Standard-A Type plug (approximately 6 mm×1 mm×0.3 mm). The Daleth Album USB uses a Standard-A Type plug. The USB Standard-A Type plug is the most common USB plug. The Standard-A type of USB plug is a flattened rectangle that inserts into a “downstream-port” receptacle on the USB host, or a hub, and carries both power and data.

### Interior

Information stored on the Daleth Album USB is the album listing (music track listing or list of songs), and the album (musical tracks).

1. Daleth Album USB is used for music artist album or collection of music artist's work.

2. Use of the Daleth Album USB in the entertainment industry for music.

3. Daleth Album USB has a Standard-A Type plug that can interface with ports in various devices, such as computers, radios and vehicles.

4. Daleth Album USB to be used to play music, vehicles, exercise machines, computers, radios and anywhere that has a capable USB port.

5. Daleth Album USB is durable.

6. Daleth Album USB reduces sound quality deterioration of music tracks in the USB.

7. Daleth Album USB is portable.

8. Exterior of Daleth Album USB is referred to as album cover art.

9. The Daleth Album USB acts as an album (a collection of music tracks), and an album cover.

10. The size of the Daleth Album USB can change for adaptability or ease of use.
